(19) United States
(12) Patent Application Publication
(10) Pub. No.: US 2010/0123306 A1
(43) Pub. Date: May 20, 2010

(54) Method And Devices For Connecting Jacketed Pipeline

(76) Inventor: Michael S. Jones, Whiteville, NC (US)

Correspondence Address: PASSE' INTELLECTUAL PROPERTY, LLC, 1717 BRASSFIELD RD., RALEIGH, NC, 27614, US

(21) Appl. No.: 12/272,837

(22) Filed: Nov. 18, 2008

(51) Int. Cl. F16L 53/00

(52) U.S. Cl. 285/41

(57) ABSTRACT

The present invention relates to a connecting flange for use in connecting jacketed pipeline and devices which connect to the jacketed pipeline. The flange allows both the flow through of media and jacket liquids without the need for a jumpover connector for the jacket fluid. The flange has a media pipe connecting area and a jacket pipe connecting area which are in tern connect via one or more connecting arms.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to devices and methods for joining and adding controls, valves and the like to jacketed piping. In particular the present invention relates to novel connector flanges for use with jacketed piping that allows them to be joined or the addition of devices in the flow of the pipeline.

2. Description of Related Art

Pipelines that carry liquids that need to be maintained at a particular temperature other than ambient temperature are often carried in jacketed pipeline. A jacketed pipeline is an inner media pipe for carrying the desired liquid that is positioned within an outer jacket pipe that carries another liquid, gas or the like for the purpose of heating or cooling the desired liquid.

Jacketed pipelines are frequently made of ferrous metals such as stainless steel, carbon steel and the like depending on the particular use. Stainless steel is the composition of choice for food, pharmaceuticals, plastic and other items where the purity of the product is of utmost importance. Carbon steel pipeline is often used to transport carbon products such as melted asphalt or sulfur products and the like. Clearly other metals or materials such as plastics could also be used for such pipelines depending on the particular use. In many embodiments, the jacket will contain a heated water stream or heated oil although, where cooling is desired, the liquid can be a cooled liquid or gas as well.

A system for transporting a heated or cooled liquid in a plant or other environment is frequently a complex array of piping requiring extraordinary long lengths, twists, turns and connections. Since pieces of jacketed pipe are not infinite in length and cannot be bent easily, if at all, pieces of such pipeline must be joined together at intervals to make longer pipelines. In addition, in order to make turns, bends, splits, junctions and the like, additional pieces of bent or shaped piping must be added to the architecture of the particular pipeline. In order to drain, stop the flow and the like of the liquid of such pipelines, stopcocks, drains and the like are also added to the mix in the flow of the jacketed pipeline. Where cleaning of the pipeline of solidified or other material is necessary (often by use of some form of pipeline “pig”) some form of access port must be provided in the pipeline.

The pieces of pipeline and the added devices in-between pieces of pipeline must be connected together. Typically, a flange is placed at each side of a connection which allows the heated or cooled liquid to continue to flow between the connected pieces. However, the current devices and methods require use of a jumpover connector to connect on either side of a flange or either side of a stopcock or drain and the like to route the heated or cooled liquid around the connection.

These types of jacketed pipeline connections represent a weakness and high cost to the construction and maintenance of a jacketed pipeline. The connections tend to be more exposed to ambient temperatures which make the cost of keeping the liquid at a selected temperature high. In addition, the cost of adding and maintaining jumpover connectors in such a way that they do not leak, adds a very high cost to any project involving jacketed pipeline since the labor involved in each additional weld in such a system is high. Further, problems include the extensive time needed to drain such a system during shut down (for example over a weekend). Shutdowns and start ups often can take hours and hours to accomplish. In general, the addition of all these specialized jumpover connections require a great deal of onsite construction and welding personnel, thus further adding to the cost, time and difficulty of using jacketed pipelines.

U.S. Pat. No. 4,521,039 issued Jun. 4, 1985 to Schulz is an example of a connecting flange for connecting jacketed piping. As can be seen from the drawings and description of the invention, the inner pipeline is connected using the flange but the jacketed liquid needs to be shuttled around the connection using this flange. This type of connections is still the type used everywhere to make such connections

### BRIEF SUMMARY OF THE INVENTION

The present invention relates to a novel flange and its use in attaching jacketed pipeline and jacketed pipeline devices to one another allowing flow-through of both media and cooling or heating liquids. Pairs of flanges can be matched and easily connected to form seals and eliminate or reduce many of problems of the current methods for joining such devices.

In one embodiment the invention relates to a connecting flange coupling half for a jacketed pipeline system device having a jacket pipe and a media pipe comprising:
a) a mating face adapted for mating against another connecting flange coupling half;
b) a mounting face adapted for attaching a jacketed pipeline system device;
c) a media pipe attachment area on the mounting face having a media pipe bore for fluid communication with a media pipe attached to the mounting face, the media pipe bore passing through the flange from the mounting face to the mating face;
d) a jacket pipe attachment area on the mounting face having one or more jacket pipe bores for fluid communication with a jacket pipe attached to the mounting face the one or more jacket pipe bores passing through the flange from the mounting face to the mating face, the jacket pipe attachment area connected to the media pipe attachment area by one or more connecting arms.

The present invention also comprises a method of connecting the connecting ends of two jacketed pipeline system devices having a jacket pipe and a media pipe comprising;
a) mounting a connecting flange coupling half for a jacketed pipeline system device to each connecting end, each flange comprising:
   i. a mating face adapted for mating against another connecting flange coupling half;
   ii. a mounting face adapted for attaching a jacketed pipeline system device;
   iii. a media pipe attachment area on the mounting face having a media pipe bore for fluid communication with a media pipe attached to the mounting face, the media pipe bore passing through the flange from the mounting face to the mating face;
   iv. a jacket pipe attachment area on the mounting face having one or more jacket pipe bores for fluid communication with a jacket pipe attached to the mounting face the one or more jacket pipe bores passing through the flange from the mounting face to the mating face, the jacket pipe attachment area connected to the media pipe attachment area by one or more connecting arms.
b) mating the two mating faces together;
c) connecting the two flanges together with a connecting device.

### BRIEF DESCRIPTION OF THE DRAWINGS

FIG. 1 is a mating face view of a flange of the present invention.

FIG. 2 is a side view with grove and bore indications of a flange of the present invention.

FIG. 3 is a mating face view of a flange of the present invention with bore holes for connection bolts.

FIG. 4 is a side view showing a flange of the present invention attached to a jacketed pipe.

FIG. 5 is a view of a flange of the present invention as viewed from a jacketed pipeline.

FIG. 6 is a mating face view of a flange of the present invention which is attached to a stopcock valve.

FIG. 7 is a side view of a stopcock valve with media pipe and jacket pipe having a flange of the present invention at each mounting end.

FIG. 8 is a side view of two pieces of jacketed pipeline if cutaway view each with a flange of the invention where the mating faces of the two flanges are mated.

FIG. 9 is the same view as FIG. 8 wherein the two flanges are clamped together by means of a sanitary clamp.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “media pipe” refers to an inner pipe in a jacketed pipeline system which is designed to carry a liquid or other material that needs to be kept at a particular temperature. Typical media in the media pipe are pharmaceuticals, foods, waxes, plastics, asphalt, sulfur compositions and the like which must either be chilled or must be kept in a heated condition to remain liquid or at least liquid enough to flow through a media pipe. In the case of products requiring high purity typically the pipe is made of stainless steel. Where less purity is acceptable, carbon steel or other heat conductive material would typically be used. The term “jacket pipe” refers to a pipe surrounding a media pipe designed to conduct a heated or chilled liquid for the purpose of maintaining media in the media pipe at a given temperature. Typical liquids used in jacket pipes include water oils and in some cases gases. The particular liquid and the exact temperature is determined by the particular media and conditions in the environment but that temperature decision is within the skill in the art. When used together these two pipes are a jacketed pipeline. The jacket pipe can be the same or different material as the media pipe and frequently the jacket pipe is insulated on the outside to prevent heat exchange with the ambient surroundings.

As used herein a “jacketed pipeline system device” refers to either jacketed pipeline or any other device which is connected, inline, to a jacket pipeline and has both media pipe and jacket pipe. Examples, of such other devices are stopcocks, drains, valves, connector pieces such as bends, adaptors and the like and in general any device which will carry both media and jacket liquid. While many of these devices are either previously unavailable or impractical prior to the present invention flange, one can easily see (for example the stopcock of the figures) that new devices can be used or developed in view of the present invention.

A “connecting flange couple half” refers to a flange for connecting jacketed pipeline system devices. It is referred to as a couple half because a flange must be at the end of each device desired to be joined, then the two flanges mated together and then connected together to achieve a seal when coupling such devices. A flange is in general a circular shaped device, but other shapes will work as well as long as the functional parts of the flange are present when mating and connecting two flanges. Therefore, rectangular or wavy shapes might be to accommodate bolt bores to pass bolts through for connecting, or the like, is within the scope of the present invention.

A “mating face” refers to the side of the flange which is adapted such that it mates with a second connecting flange coupling half and makes a seal preventing liquids from leaking out of the connection. In general, identical flanges are used on either side of a connection and thus the mating faces in some embodiments match identically in surface area dimensions. While in some embodiments the mating surface is on one level plane and in some embodiments the more central area of the mating face surrounding the media bore can be raised slightly to ensure a leak free seal of the media portion of two jacketed pipeline devices. The mating face can also have grooves, or the like, to accommodate holding or positioning of a gasket that is used to help with the sealing of mated matting faces. In general there must be enough of a surface on the mating face that matches up with another flange mating face such that two mated matting surfaces create a seal around the media pipe bore and the jacket pipe bore. A clear example of this is shown in the drawings.

A “mounting face” is the side opposite the mating face and is adapted to attach the mating end of a jacketed pipeline system device to another such device via a second flange. The mounting face, thus, is the area for mounting a mating end of a device. The attachment of both a media pipe and a jacket pipe of the device must be accomplished in a sealed manner in order to vent leaks of any liquids from the system or intermingling of liquids within the system.

The mounting face has two attachment areas for attaching both the media pipe and jacket pipe of the jacketed pipeline system device. The first area is a media pipe attachment area. This area is adapted to receive the open media pipe end of a given device and sealably attach it thereto. That is normally done by welding but any means of sealing the two together is contemplated. The surface of the media pipe attachment area is generally flat but a slot adapted to receive the end of the media pipe can also be done as shown in the figures which follow. There the pipe can be placed in the slot (circular or as needed) and thus it is easier to hold the pipe in place and weld the media pipe portion of the device without leaks occurring. The media pipe attachment area has a bore in it for aligning with a bore in the media pipe and passing fluid through the flange from the mounting face to the mating face. Thus, the liquid can be passed to a similar bore in the second flange and eventually through the second flange to the mated media pipe. The jacket pipe attachment area is positioned circumferentially around the media pipe attachment area. It is adapted to receive the open end of the jacket pipe portion of the device and sealably attach it thereto. That is normally done by welding but any means of sealing the two together is contemplated. The surface of the jacket pipe attachment area is generally flat but a slot adapted to receive the end of the media pipe can also be done similar to the media attachment area. There the pipe can be placed in the slot (circular or as needed) and thus, it is easier to hold the pipe in place and weld the pipe portion of the device without leaks occurring. There is one or more bore in this area for aligning with bores in the jacket pipe portion of the device and passing fluid through the flange from the mounting face to the mating face. The liquid can thus be passed to a similar bore in a second flange and on to a second device like the media liquid.

The two attachment areas can be relatively planar in some embodiments and not in other embodiments. It is clear that the area's size is adapted to the particular device being attached since jacketed systems can be minute to gigantic in size. It is also clear from the description that since one area circumscribes the other with bores separating them that there must be a connection area between them to prevent them from being separate. One or more connecting arms connect the two mounting areas since the mounting arms are between the two areas and span the jacket bore(s), the number of arms will determine the number of jacket bores in the particular flange. In the drawings which follow 2 arms are shown and thus 2 jacket bores. One arm would mean a single bore, 3 arms 3 bores and the like. The number of arms will depend on their size placement and the like but in view of the drawings and disclosure are within the skill in the art to determine. The length of the arms determines the relative placement of the two areas so their length is determined by the jacketed pipeline system device the flange is being used on. As noted, generally the flange is manufactured out of a single piece of material. If the material is metal it can be cast, forged or carved or the like. It can be made by any means known in the art and is within the skillof the art. Relative to one another, the two mating face side of each attachment area can be flat or the media pipe attachment area mating face can be slightly raised (from about zero to about 0.005 of an inch) relative to the jacket pipe attachment area mating face side. By raising the media pipe attachment area mating face, it is insured that when that area mates the corresponding area in a second flange the two areas will be in full contact and increased sealing pressure will occur. As long as the difference is not that substantial, the pressure of the sealing means between the two flanges will insure that both mating face sides of the flange will meet and seal.

As mentioned above the flanges can be adapted to receive one or more gaskets for increasing the sealing capacity of the flanges. In general, pipe flange gaskets are circumferentially placed around either or the media bore and jacket bore(s). Circular type gaskets (or any relatively useful shape) are used and a wide variety of materials can be adapted for this purpose. Examples include Teflon, graphite, gylon, durlon, viton, nylon, PTFE, red rubber and Gortex. Others known or developed in the art could likewise be used. As noted above optionally a gasket groove can be provided in the flange mating face for positioning or holding the gasket. Sealing gels and greases can also be used where appropriate to the materials being joined to improve dealing of two flanges.

In one embodiment, in order to aid in aligned two flanges for mating, an external mating grove or mark is used. That way the connecting arms are in alignment during use and do not unnecessarily interfere with liquid flow due to misalignment. In one embodiment a notch on the circumference of the flange serves this purpose.

Once two flanges mating faces are mated the two need to be connected together with a connecting device with sufficient force to keep them together and keep them from leaking. Any device for holding the two flanges together with force is contemplated by the present invention. One way of doing this is to provide fixing bolt bores in the flange and then use fixing bolts to bolt the two flanges together. The drawings show a typical 4 bore arrangement for a flange. Another way to do this is to taper the circumferential edge of each flange on the mounting half of the flange. When a circumferential compression clamp, such as a sanitary clamp, is placed around the two flanges, tightening the clamp presses against the angled edges of the flange and forces them together evenly around the entire circumference of the flanges. Since these types of connecting devices are readily available and inexpensive this becomes a desirable embodiment of the present invention.

The mating face of the flange of the invention can be smooth or parts of it can be textured. Textured flange surfaces can be used to position and hold gaskets and can increase holding pressure when two flanges are mated and connected together. In use then the flanges of the invention would be mounted on the ends of a jacketed pipeline system device. The mating face of two flanges would be mated and then a connecting device used to connect the two flanges and seal the connection. This is done for an entire jacketed system to include pieces of jacketed pipeline and those devices inserted in the flow of the desired media.

In one embodiment of the invention the bores are solid in order to make a blind flange of the present invention.

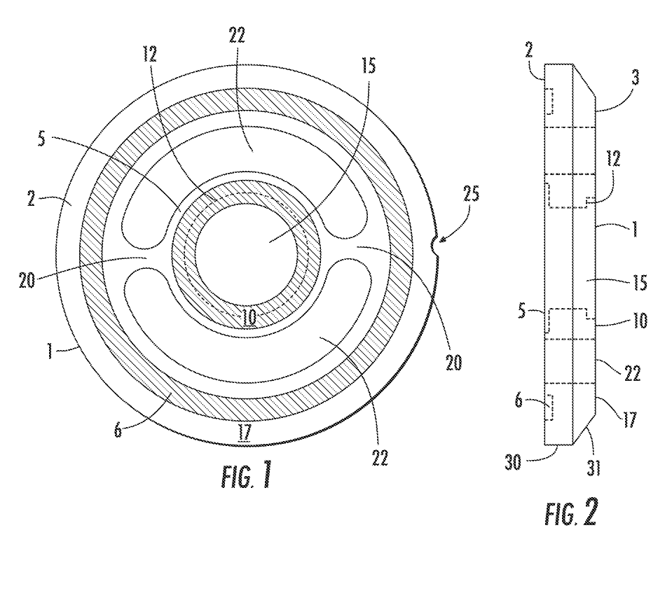

Now referring to the drawings. FIG. 1 is a flange 1 of the present invention. Flange 1 is shown with mating face 2 facing the viewer. The mounting face 3 is the opposite side of the flange 1. As described above the mating face is adapted to mate against another flange's mating face. In this embodiment the mating face is flat except for media pipe gasket groove 5 and jacket pipe gasket groove 6. The groves 5 and 6 are shown without a gasket but one could easily place a round gasket of a desired material as described above in the grooves for use in mating and connection to a second flange's mating face. The mating face side of the media pipe attachment area 10 is the center circular area of the flange 1. Media pipe groove 12 is shown as a dashed line in see through perspective. Media pipe groove 12 is designed and shaped to place the open end of a media pipe portion of a jacketed pipe in place for welding or other attachment means to flange 1.

Media bore 15 is in the center of media pipe attachment area 10. It is of a size and shape to mate as a pass through the flange of liquid in the media pipe device attached to the flange 1. The mating side of jacket pipe attachment area 17 is shown as the other concentric area of the flange 1 which holds the jacket pipe gasket groove 6 on the mating face side. In this embodiment there is no jacket pipe groove and thus the jacket pipe attached to flange 1 would be welded or otherwise attached directly to the mounting face 3 and not embedded in the mounting face 3 as shown for the media pipe groove 12 above.

The media pipe attachment area 10 is attached to the jacket pipe attachment area by two connecting arms 20. The media arms 20 are of a thickness such that media flowing through both a media and jacket pipe do not break the arm or otherwise misalign connecting arms 20 as shown, but it is clear that any number, one, two, three four or more connecting arms 20 could be used as desired. Each connecting arm 20 that is used in the present invention creates a jacket pipe bore 22. In the case of the two connecting arms 20 shown, two jacket bores are created. As discussed above more or less bores can be created as desired. The shape of the connecting arm 20 can be straight or tapered or as desired but is within the skill in the art in keeping with the flowing liquid forces acting on the connecting arms 20 in each situation the flange 1 is used. An optional alignment notch 25 is depicted. When matching two flanges if the alignment notches are matched up the connecting arms 20 of each flange 1 would be aligned thus maximizing the flow through of each bore by liquid media.

FIG. 2 is a side view of the flange 1 of FIG. 1. In this perspective view, the bores and groves can be seen in dotted line see through view. The attachment face side is also indicated. This side view shows flange edge 30 having tapered edge 31. The tapered edge 31 is useful as described above with sanitary clamps at creating a compression force with two mated flanges 1.

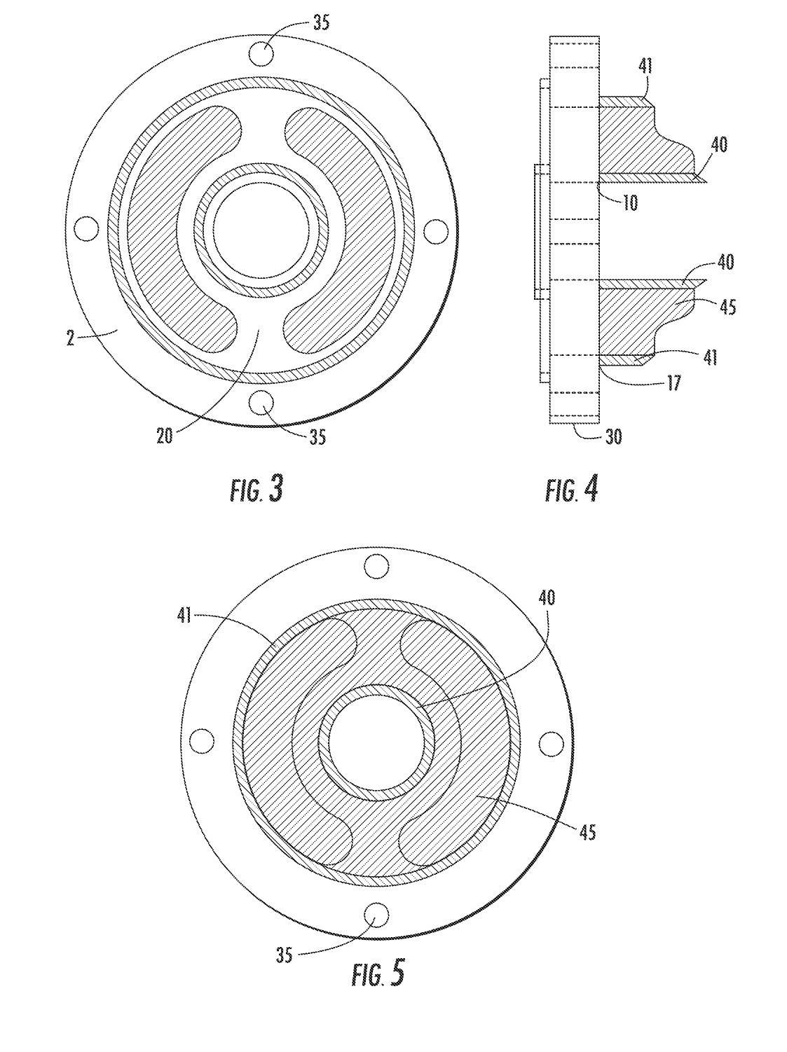

FIG. 3 is a mating face view of another embodiment of flange 1 with a jacket pipeline (seen in FIG. 4) attached to the mounting face 3. This version is designed for larger pipelines and is provided with 4 fixing bolt bores 35. Fixing bolts can be passed through the holes in two mating face mated flanges 1 and bolted together to create the necessary connecting force on two flanges. Note in this view there is no media or jacket pipe attachment grove and thus the media and jacket pipes are connected directly to the mounting face and not in a groove of any kind. Since the flange is designed for larger pipes the connecting arms in this view are much thicker than in FIG. 1. This is necessitated by the larger volume of liquid passing by the arms. The gasket grooves are portrayed as much narrower but since the flange is actually much larger than the flange 1 in FIG. 1, they are actually of similar width. However, the size of the gaskets used of course is variable within the skill in the art.

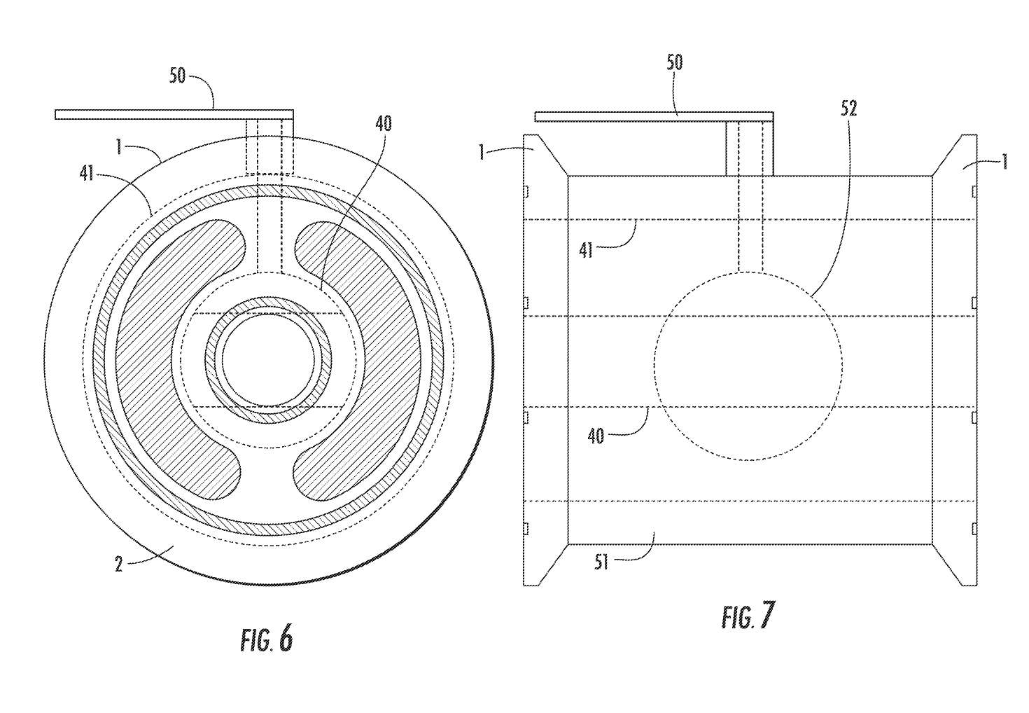

FIG. 4 is a side view of flange 1 depicted in FIG. 3. In this view one can see the jacketed pipeline consisting of the media pipe 40 and jacket pipe 41 in cut through view and welded to the media pipe attachment area 10 and jacket pipe attachment area 17 respectively. The flange edge 30 is flat in this embodiment and no tapered edge is used since fixing bolts are the connection method for this flange 1. This embodiment shows that the mating face 2 side of the media pipe attachment area 10 is raised with respect to the rest of the mating face 3 of flange 1. In this embodiment it is about 0.002 inches, but is exaggerated for viewing purposes. When two mating faces 2 of this embodiment are mated and connected the compression forces of connecting draw both faces completely together with more force being applied to the media pipe area than the jacket pipe area thus insuring a better media pipe seal especially with large pipes. Jacket media 45 is shown and no media is depicted in the media pipe. FIG. 5 is a view of the flange 1 of FIG. 3 from the perspective of the mounting face, i.e. from the jacketed pipeline. Thus, one can see where the liquid 45 in the jacket is from this perspective.

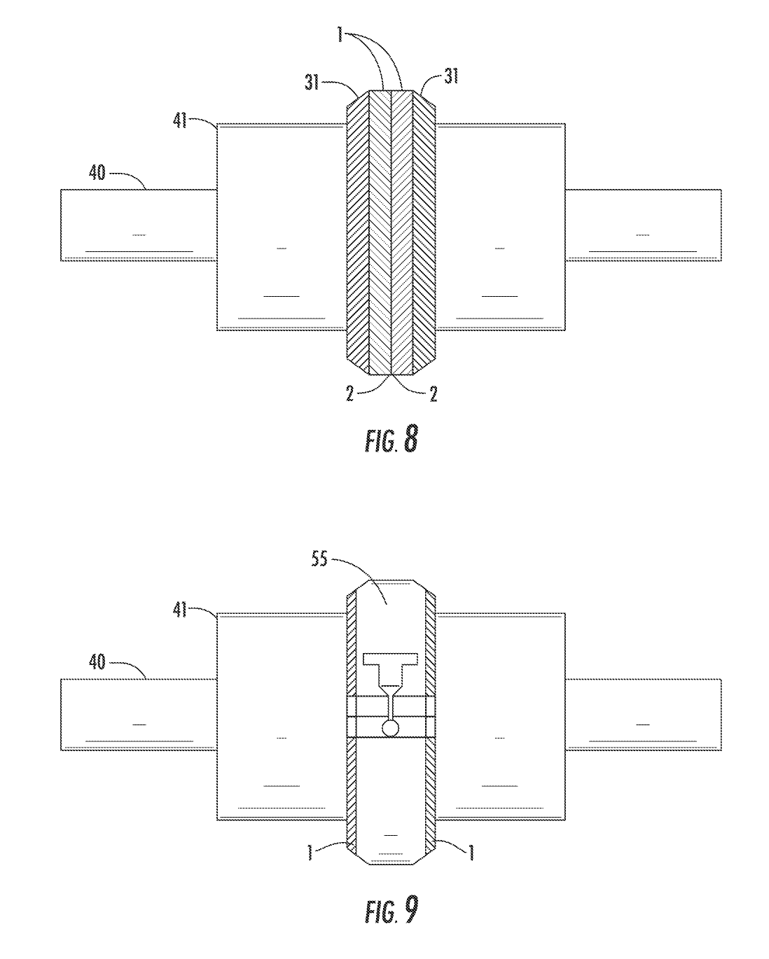

FIG. 6 is a mating face 2 perspective of a flange 1 of the present invention attached to a ball stopcock having flow through media and jacket pipes. Stopcock valve 50 is shown. Otherwise the flange 1 is the same as other perspective flanges 1. FIG. 7 is a side view of a flow through stopcock valve 51 having stopcock valve 51 and stopcock ball 52 for turning the flow in the media pipe 40 on and off.

FIG. 8 is a side view of two pieces of jacketed pipeline with media pipe 40 and jacket pipe 41 each having a flange 1 of the present invention, wherein the two mating faces 2 have been mated but not yet connected. FIG. 9 is the same two pieces of pipeline with a sanitary clam 55 tightened around the two flanges 1 holding them connected.

As can be readily seen various changes in size, shape, connecting devices, materials, bore sizes, gaskets and the like can all be made in view of the disclosure herein. The claims which follow are not intended to be limited by the drawings or otherwise by the description unless otherwise noted.

What is claimed is:

1. A connecting flange coupling half for a jacketed pipeline system device having a jacket pipe and a media pipe comprising:
a) a mating face adapted for mating against another connecting flange coupling half;
b) a mounting face adapted for attaching a jacketed pipeline system device;
c) a media pipe attachment area on the mounting face having a media pipe bore for fluid communication with a media pipe attached to the mounting face, the media pipe bore passing through the flange from the mounting face to the mating face;
d) a jacket pipe attachment area on the mounting face having one or more jacket pipe bores for fluid communication with a jacket pipe attached to the mounting face, the one or more jacket pipe bores passing through the flange from the mounting face to the mating face, the jacket pipe attachment area connected to the media pipe attachment area by one or more connecting arms.

2. A connecting flange according to claim 1 wherein there are two connecting arms.

3. A connecting flange according to claim 1 wherein there is a groove on the mating face for placing a gasket around the one or more jacket pipe bore.

4. A connecting flange according to claim 1 wherein there is a groove on the mating face for placing a gasket around the media pipe bore.

5. A connecting flange according to claim 1 wherein there is one or more alignment marks on the circumference of the flange for aligning the arms of two mated connecting flanges.

6. A connecting flange according to claim 1 wherein there are attachment groves on the mounting face positioned around the media pipe bore for insetting a media pipe.

7. A connecting flange according to claim 1 wherein there are attachment groves on the mounting face positioned around the jacket pipe bore for insetting a jacket pipe.

8. A connecting flange according to claim 1 wherein there are fixing bolt bores there through for the connecting flange to mate and connect to another connecting flange with fixing bolts.

9. A connecting flange according to claim 1 wherein the circumference is shaped such that when the connecting flange is mated against another connecting flange in can be held together with a circumferential compression clamp.

10. A connecting flange according to claim 1 wherein the flange is attached to the end of a jacketed pipe.

11. A connection flange according to claim 1 wherein the jacketed pipe is stainless steel.

12. A connection flange according to claim 1 wherein the jacketed pipe is carbon steel.

13. A connecting flange according to claim 1 wherein the flange is attached to a stopcock having a media pipe and a jacket pipe.

14. A connecting flange according to claim 1 wherein the flange is attached to a drain valve having a media pipe and a jacket pipe.

15. A connection flange according to claim 1 wherein a portion of the mating face is texture to accept a mating gasket.

16. A connection flange according to claim 1 wherein the mating face side opposite the media pipe attachment area is raised in relationship to the remainder of the mating face.

17. A connection flange according to claim 1 which further comprises one or more gaskets for use in attaching the flange to another flange.

18. A connection flange according to claim 1 wherein the bores have been filled to produce a blind flange.

19. A method of connecting the connecting ends of two jacketed pipeline system devices having a jacket pipe and a media pipe comprising;
a) mounting a connecting flange coupling half for a jacketed pipeline system device to each connecting end, each flange comprising:
i. a mating face adapted for mating against another connecting flange coupling half;
ii. a mounting face adapted for attaching a jacketed pipeline system device;
iii. a media pipe attachment area on the mounting face having a media pipe bore for fluid communication with a media pipe attached to the mounting face, the media pipe bore passing through the flange from the mounting face to the mating face;
iv. a jacket pipe attachment area on the mounting face having one or more jacket pipe bores for fluid communication with a jacket pipe attached to the mounting face the one or more jacket pipe bores passing through the flange from the mounting face to the mating face, the jacket pipe attachment area connected to the media pipe attachment area by one or more connecting arms.
b) mating the two mating faces together;
c) connecting the two flanges together with a connecting device.

20. A stopcock for use with a jacketed pipeline comprising a media pipe and a jacket pipe.
